(19) United States
(12) Patent Application Publication
(10) Pub. No.: US 2018/0326350 A1
(43) Pub. Date: Nov. 15, 2018

(54) DICHLOROMETHANE RECOVERY SYSTEM

(71) Applicant: Tesla, Inc., Palo Alto, CA (US)

(72) Inventor: Turner Boris Caldwell, San Francisco, CA (US)

(73) Assignee: Tesla, Inc., Palo Alto, CA (US)

(21) Appl. No.: 15/976,717

(22) Filed: May 10, 2018

Related U.S. Application Data
(60) Provisional application No. 62/505,346, filed on May 12, 2017.

(51) Int. Cl. B01D 53/14; B01D 53/18

(52) U.S. Cl. CPC B01D 53/1493; B01D 53/1487; B01D 2252/103; B01D 53/1425; B01D 53/18

(57) ABSTRACT

An exhaust stream treatment system includes a wet scrubber having an inlet for accepting waste exhaust containing dichloromethane, a water inlet for accepting water to be used to scrub the waste exhaust containing dichloromethane, a chamber in which the water is used to scrub the waste exhaust containing dichloromethane, an outlet for expelling dichloromethane-free exhaust, and a water outlet for expelling water and dichloromethane. The exhaust stream treatment system further includes a density separation vessel having an inlet for accepting the water and dichloromethane output by the wet scrubber, an outlet for expelling dichloromethane, and a water outlet for expelling waste water. The system may further include a waste water return loop from the waste water outlet of the density separation vessel to the water inlet of the wet scrubber. The system may further include a condenser that condenses the dichloromethane-free exhaust and a condensed water return loop.

### CROSS-REFERENCE TO RELATED APPLICATION

The present U.S. Utility Patent Application claims priority pursuant to 35 U.S.C. § 119(e) to U.S. Provisional Application No. 62/505,346, entitled “DICHLOROMETHANE RECOVERY SYSTEM”, filed 12 May 2017, which is hereby incorporated herein by reference in its entirety and made part of the present U.S. Utility Patent Application for all purposes.

### BACKGROUND

### Technical Field

The present invention relates to process recovery; and more particularly to the treatment of air exhaust containing dichloromethane to recover the dichloromethane.

### Description of Related Art

Dichloromethane (DCM) is used in a variety of industrial processes, including chemical plastic welding in which softened plastic pieces or surfaces may be welded together, to soften plastic sheets for stretching or shaping, and as a solvent to remove unwanted compounds. More specifically, DCM is used in the forming of a separator base film for use in an electric-vehicle battery system. In the separator manufacturing process, DCM is commonly used to extract a plasticizer (commonly a mineral oil) used in the earlier base film extrusion steps. The DCM itself may then be removed through a heating and/or evaporation process with the exhaust collected. This exhaust containing DCM is then combined with the exhaust from other tools and systems used in the manufacturing process. The combined exhaust may then be fed to a recovery plant to recover DCM. In the recovery plant, the waste exhaust stream is typically treated with activated carbon. This scrubbing process requires high capital expenditure (many expensive components), high operating cost (extensive steam and cooling water consumption which accounts for >20% of total process cost), large footprint requirements, and large amounts of waste water that need to be processed. In order to address these cost and environmental-remediation issues, an improved process for the removal of DCM from exhaust streams is needed.

### SUMMARY

In order to overcome the shortcomings of the industry standard recovery method, a first embodiment of the present disclosure is an exhaust stream treatment system that includes a wet scrubber and a density separation vessel. The wet scrubber includes an inlet for accepting process exhaust air containing dichloromethane (DCM), an inlet for accepting water to be used to scrub this exhaust, a chamber containing a packed bed in which the water is used to scrub DCM from the exhaust, an outlet for expelling dichloromethane-free exhaust and a water outlet for expelling a water/DCM mixture. The density separation vessel includes an inlet for accepting the water and dichloromethane output by the wet scrubber, an outlet for expelling dichloromethane, and a water outlet for expelling waste water.

The first embodiment provides the important benefits of nearly complete recovery of the dichloromethane while producing nearly pure waste water. Further, the first embodiment is more efficient than prior systems and methods, saving energy, equipment, and operating expenses.

A first aspect of the first embodiment includes a waste water return loop from the waste water outlet of the density separation vessel to the water inlet of the wet scrubber. With this first aspect, the waste water is recycled, saving both disposal costs and scrubbing water costs.

According to various aspects of the first embodiment, the exhaust stream contains greater than 1% by volume of dichloromethane or greater than 2% by volume of dichloromethane.

According to a second aspect of the first embodiment, the expelled dichloromethane is reused as part of an industrial process, which provides the benefits of reduced costs in both material procurement and disposal.

According to a third aspect of the first embodiment, the exhaust stream treatment system includes a condenser having an inlet for accepting the dichloromethane-free exhaust and an outlet for expelling condensed water. With this third aspect, the exhaust stream treatment system may further include a condensed water return loop from the outlet of the condenser to the water inlet of the wet scrubber, which reduces water procurement and disposal expenses.

According to a fourth aspect of the first embodiment, the exhaust stream treatment system may further include a waste water treatment system having an inlet for accepting the waste water from the density separation vessel and an outlet for expelling treated water. With this fourth aspect, the waste water may be released to a city waste-water system or reused by the wet scrubber.

A second embodiment of the present disclosure is directed to a method for treating waste exhaust containing dichloromethane. The method includes receiving waste exhaust containing dichloromethane at a first inlet of a wet scrubber, receiving water at a water inlet of the wet scrubber, scrubbing the waste exhaust containing dichloromethane using the water by the wet scrubber, expelling dichloromethane-free exhaust from the wet scrubber, and expelling water and dichloromethane from the wet scrubber. The second embodiment further includes receiving the water and dichloromethane output by the wet scrubber at an inlet of a density separation vessel and separating the water from the dichloromethane by the density separation vessel into waste water and dichloromethane.

The waste exhaust may contain greater than 1% by volume of dichloromethane or contain greater than 2% by volume of dichloromethane.

According to a first aspect of the second embodiment, the method includes returning the waste water from the density separation vessel to the water inlet of the wet scrubber. According to a second aspect of the second embodiment, the method further includes reusing the expelled dichloromethane as part of an industrial process.

According to a second aspect of the second embodiment, the method includes receiving the dichloromethane-free exhaust by a condenser and condensing the dichloromethane-free exhaust to produce condensed water.

According to a third aspect of the second embodiment, the method includes returning the condensed water from the condenser to the water inlet of the wet scrubber.

According to a fourth aspect of the second embodiment, the method further includes treating the waste water using a waste water treatment system. Alternately, the method may include releasing the waste water to a city waste-water system.

The second embodiment and its various aspects provide similar benefits as does the first embodiment and its various aspects.

### BRIEF DESCRIPTION OF THE SEVERAL VIEWS OF THE DRAWINGS

FIG. 1 is a system diagram illustrating a prior art system for treating a waste exhaust stream containing dichloromethane.

FIG. 2 is a system diagram illustrating an exhaust treatment system for treating a waste exhaust stream containing dichloromethane.

FIG. 3 is a flow chart illustrating operation of an exhaust treatment system for treating a waste exhaust stream containing dichloromethane.

### DETAILED DESCRIPTION OF THE DISCLOSURE

An exemplary process that generates exhaust containing dichloromethane (DCM, chemical formula. CH₂Cl₂) is the manufacture of a separator base film for use in an electric-vehicle battery system, a plastic sheathing for use in an electric-vehicle battery system may be rolled and stretched using a mineral-oil plasticizer followed by application of DCM to drive off the mineral oil. The DCM is then typically driven off using heat and/or evaporation producing exhaust containing DCM. In the prior state-of-the-art systems, the exhaust for all of the different processes are collected together and then treated to remove DCM.

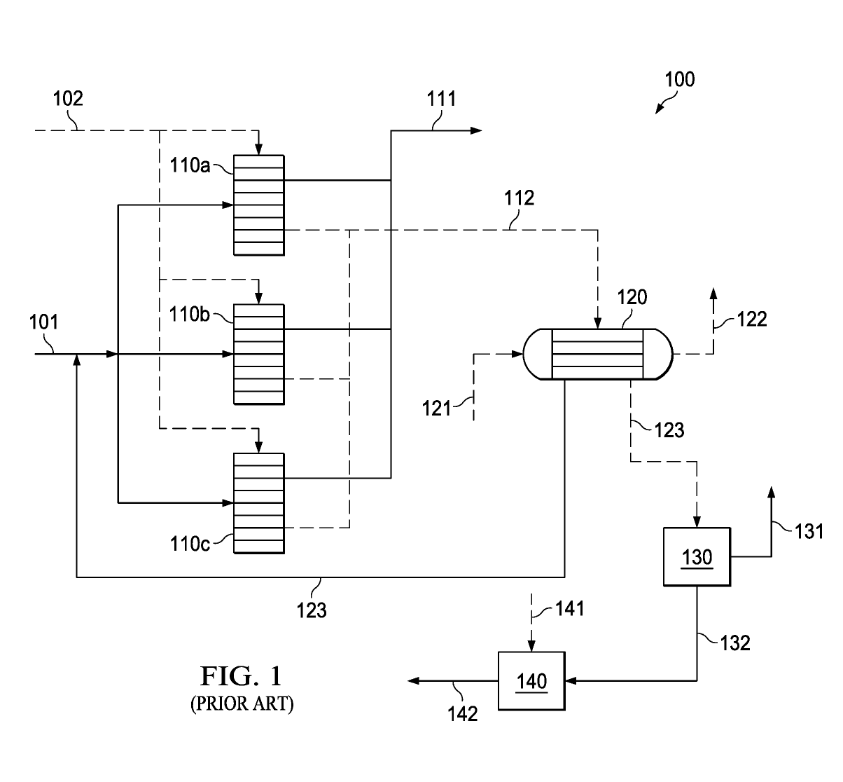

FIG. 1 is a system diagram illustrating a prior art system 100 for processing a waste exhaust stream 101 containing dichloromethane. Waste exhaust stream 101 is typically collected from many different exhaust vents from multiple tools and processes, with only a small portion of the exhaust vents venting DCM. This results in a diluted DCM waste exhaust within a large volume of exhaust. This waste exhaust stream 101 is sent to activated carbon beds 110a, 110b, and 110c. Air recirculated from condenser 120 may be part of the waste exhaust stream 101 sent to the activated carbon beds 110a-c. The activated carbon beds adsorb the DCM in the waste exhaust, and the DCM is subsequently removed from the activated carbon beds using steam 102. DCM-free exhaust 111 may then be released to the atmosphere from the activated carbon beds 110a-c.

The DCM and steam 112 is then condensed by condenser 120 (with water inlet 121 and outlet 122) to form a stream of water and DCM 123. This stream of water and DCM 123 is then sent to a density separator vessel 130 to separate the DCM from the water, using the difference in density between the DCM and water—DCM has a density of 1.33 g/cm³ and water has a density of 1 g/cm³. The recovered DCM 131 may then be sent back to the industrial process that uses it or saved for another process. Waste water 132 from the density separation vessel 130 typically still contains DCM in high enough concentrations that it cannot be reused. Rather, waste water 132 must be treated by waste water treatment system 140 using additional input 141. Treated waste water 142 may then be discharged to the municipal or other system.

System 100 results in high capital expenditures because there are many expensive components (for example, activated carbon beds, condenser, steam boilers and distribution system, density separation vessel, and waste water treatment system). Using system 100 to recover DCM also results in high operating cost (extensive steam and cooling water consumption can account for a large percentage (>20%)) of total process cost. System 100 also requires a large footprint and large amounts of waste water to be processed.

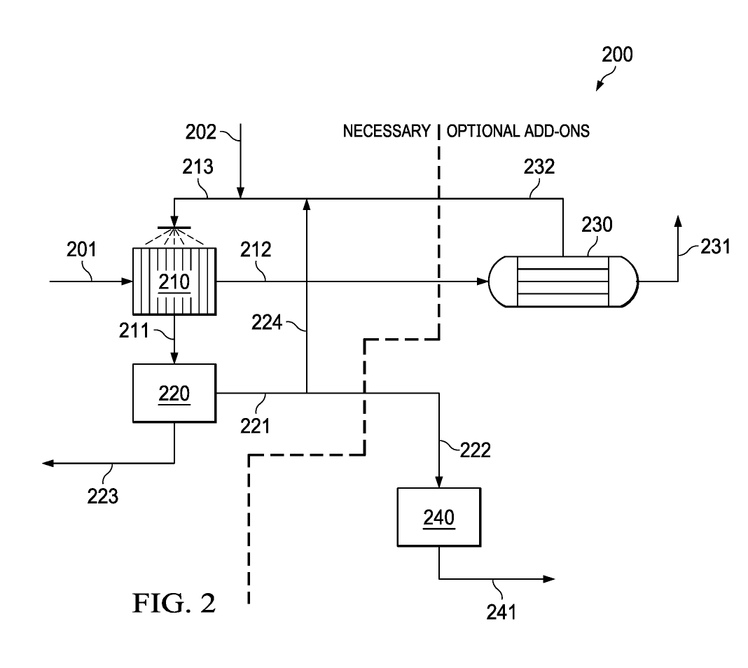

FIG. 2 is a system diagram illustrating an exhaust treatment system 200 for treating a waste exhaust stream 201 containing DCM according to a disclosed embodiment of the present disclosure. Preferentially a waste exhaust stream 201 contains a high concentration of DCM (for example, greater than 1-2% by volume or moles of DCM), which allows for maximum efficiency gains, although lower concentrations may also be treated. Higher concentrations of DCM in the waste exhaust stream 201 may be obtained by directly treating the exhaust generated from processes and/or tools that use DCM without diluting by mixing other exhaust streams.

Exhaust treatment system 200 includes a wet scrubber 210 and density separator vessel 220. Optionally, exhaust treatment system 200 also includes a condenser 230 and waste water treatment system 240. The wet scrubber 210 has an inlet to receive the waste exhaust stream 201 and an outlet to expel DCM-free exhaust 212. The DCM-free exhaust 212 may be expelled directly to the air, or if the exhaust has a high concentration of water vapor, the water may be collected using a condenser 230 and reclaimed water 232 reused (this is particularly useful in areas where access to water is limited). The wet scrubber 210 has an inlet for water 213, a water inlet, a chamber in which the water is used to scrub the waste exhaust containing dichloromethane, and an outlet for expelling water and DCM 211. Water 213 may come from water from the city 202, waste water recirculated through from the density separator vessel 220, condensed water recirculated from the optional condenser 230, water from another source, or any combination thereof.

The wet scrubber has a scrubbing chamber (or packed bed) in which the water 213 is used to scrub the waste exhaust stream 201 containing the DCM. Various designs/structures may be employed for the wet scrubber 210 to remove DCM from the waste exhaust stream 201, including a venturi scrubber design, a condensation scrubber design, an impingement-plate scrubber design, a packed bed tower design, or another scrubber design.

The density separator vessel 220 has an inlet to receive the liquid water and DCM mixture 211, an outlet to expel DCM 223, and an outlet to expel waste water 221. The DCM 223 may be routed back to the industrial process for reuse and/or collected for later use. The waste water 221 may be routed back to the wet scrubber 210, as shown along waste water return loop 224. Waste water 221 may also or alternately be routed to waste water treatment system 240 for processing along path 222 for subsequent treatment by waste water treatment system 240. Typically, a large portion of the waste water 221 is returned to the wet scrubber 210 via waste water return loop 224 and a small portion of the waste water 221 is treated by the waste water treatment system 240. Even though the waste water 221 may contain small amounts of DCM, the waste water 221 will still retain its ability to scrub the exhaust containing DCM. An advantage of the wet scrubber 210 over the activated carbon beds is that all or most of the water 213 used by the wet scrubber 210 is the waste water 221 from the density separator vessel 220, resulting in substantial savings of water and energy, and resultantly, substantial cost savings.

The optional condenser 230 for water recovery has an inlet for the DCM-free exhaust 212, an outlet for expelling condensed water condensed from the DCM-free exhaust 212, which may be recirculated to the wet scrubber 210 via a condensed water return loop 232, and an outlet 231 to expel exhaust to the atmosphere (or elsewhere). The outlet 231 to expel exhaust may be replaced with a pressure valve. Waste water return loop 232 may return the condensed water to the scrubber 210.

Various operating characteristics, inputs, and outputs are supported by one or more structures and operations of the exhaust treatment system 200. These options may be combined in any number of ways. With the exhaust treatment system 200, the waste exhaust stream 201 has a first DCM content and the DCM-free waste exhaust 212 and/or exhaust from outlet 231 has a DCM concentration of zero (or low enough concentration to be expelled to the atmosphere).

As compared to prior exhaust treatment systems, the exhaust treatment system 200 of the present disclosure, effectively eliminates the use of steam and cooling. It also effectively eliminates or greatly reduces the amount of throughput needed by a waste water treatment system. These efficiencies eliminate capital expenditures and operating costs for the same amount of DCM processed processing. Further savings in capital expenditures and operating costs occur due to increased system simplicity and reduced airflow rates that need to be treated.

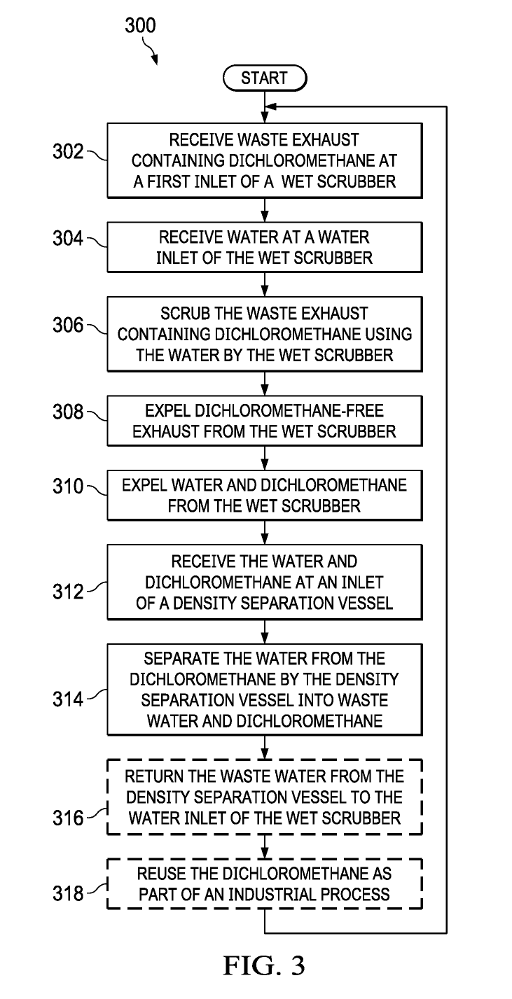

FIG. 3 is a flow chart illustrating operation of an exhaust treatment system for treating a waste exhaust stream containing dichloromethane. The method 300 includes receiving waste exhaust containing dichloromethane at a first inlet of a wet scrubber (step 302), receiving water at a water inlet of the wet scrubber (step 304), scrubbing the waste exhaust containing dichloromethane using the water by the wet scrubber (step 306), expelling dichloromethane-free exhaust from the wet scrubber (step 308), and expelling water and dichloromethane from the wet scrubber (step 310). The method 300 further includes receiving the water and dichloromethane output by the wet scrubber at an inlet of a density separation vessel (step 312) and separating the water from the dichloromethane by the density separation vessel into waste water and dichloromethane (step 314). The waste exhaust may contain greater than 1% by volume of dichloromethane or contain greater than 2% by volume of dichloromethane.

The method 300 includes optionally returning the waste water from the density separation vessel to the water inlet of the wet scrubber (step 316). Further the method 300 optionally includes reusing the expelled dichloromethane as part of an industrial process (step 318).

The method 300 may further include optionally receiving the dichloromethane-free exhaust by a condenser and condensing the dichloromethane-free exhaust to produce condensed water and returning the condensed water from the condenser to the water inlet of the wet scrubber. Further, the method 300 may optionally treat the waste water using a waste water treatment system or, alternately, release the waste water to a city waste-water system.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed system, method, and computer program product. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure.

As used herein, the terms “comprises,” “comprising,” “includes,” “including,” “has,” “having” or any contextual variants thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B is true (or present).

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, reversed, or otherwise controlled by another process.

What is claimed is:

1. An exhaust stream treatment system comprising:
a wet scrubber having:
an inlet for accepting process exhaust containing dichloromethane;
an inlet for accepting water to be used to scrub the process exhaust containing dichloromethane;
a chamber in which the water is used to scrub the waste exhaust containing dichloromethane through a packed bed;
an outlet for expelling dichloromethane-free exhaust; and
a water outlet for expelling water and dichloromethane; and
a density separation vessel having:
an inlet for accepting the water and dichloromethane output by the wet scrubber;
an outlet for expelling dichloromethane; and
a water outlet for expelling waste water.

2. The exhaust stream treatment system of claim 1, further comprising a waste water return loop from the waste water outlet of the density separation vessel to the water inlet of the wet scrubber.

3. The exhaust stream treatment system of claim 1, wherein the waste exhaust contains greater than 1% by volume of dichloromethane.

4. The exhaust stream treatment system of claim 1, wherein the waste exhaust contains greater than 2% by volume of dichloromethane.

5. The exhaust stream treatment system of claim 1, wherein the expelled dichloromethane is reused as part of an industrial process.

6. The exhaust stream treatment system of claim 1, further comprising a condenser having:
an inlet for accepting the dichloromethane-free exhaust; and
an outlet for expelling condensed water.

7. The exhaust stream treatment system of claim 6, further comprising a condensed water return loop from the outlet of the condenser to the water inlet of the wet scrubber.

8. The exhaust stream treatment system of claim 6, further comprising a waste water treatment system having:
an inlet for accepting the waste water from the density separation vessel; and
an outlet for expelling treated water.

9. The exhaust stream treatment system of claim 1, wherein the waste water is released to a city waste-water system.

10. The exhaust stream treatment system of claim 1, further comprising a waste water treatment system having:
an inlet for accepting the waste water from the density separation vessel; and
an outlet for expelling treated water.

11. A method for treating waste exhaust containing dichloromethane comprising:
receiving waste exhaust containing dichloromethane at a first inlet of a wet scrubber;
receiving water at a water inlet of the wet scrubber;
scrubbing the waste exhaust containing dichloromethane using the water by the wet scrubber;
expelling dichloromethane-free exhaust from the wet scrubber;
expelling water and dichloromethane from the wet scrubber;
receiving the water and dichloromethane output by the wet scrubber at an inlet of a density separation vessel; and
separating the water from the dichloromethane by the density separation vessel into waste water and dichloromethane.

12. The method of claim 11, further comprising returning the waste water from the density separation vessel to the water inlet of the wet scrubber.

13. The method of claim 11, wherein the waste exhaust contains greater than 1% by volume of dichloromethane.

14. The method of claim 11, wherein the waste exhaust contains greater than 2% by volume of dichloromethane.

15. The method of claim 11, further comprising reusing the expelled dichloromethane as part of an industrial process.

16. The method of claim 11, further comprising:
receiving the dichloromethane-free exhaust by a condenser; and
condensing the dichloromethane-free exhaust to produce condensed water.

17. The method of claim 16, further comprising returning the condensed water from the condenser to the water inlet of the wet scrubber.

18. The method of claim 11, further comprising treating the waste water using a waste water treatment system.

19. The method of claim 18, further comprising releasing the waste water to a city waste-water system.
